(19) United States
(12) Patent Application Publication
(10) Pub. No.: US 2024/0073578 A1
(43) Pub. Date: Feb. 29, 2024

(54) EARPHONE HOUSING AND EARPHONE

(71) Applicant: YAMAHA CORPORATION, Hamamatsu-shi (JP)

(72) Inventors: Yasuaki TAKANO, Kikugawa-shi (JP); Tomoaki MORI, Hamamatsu-shi (JP); Masafumi FUTO, Hamamatsu-shi (JP)

(21) Appl. No.: 18/351,543

(22) Filed: Jul. 13, 2023

(30) Foreign Application Priority Data
Aug. 26, 2022 (JP) 2022-134759

(51) Int. Cl. H04R 1/10

(52) U.S. Cl. CPC H04R 1/1016; H04R 1/1058

(57) ABSTRACT

An earphone includes an inserter configured to be inserted into an outer ear hole of an ear, a main body configured to be coupled to the inserter, and an earpiece covering the inserter. The main body includes a bottom surface and a side surface that are configured to contact a surface of a cavum concha. The side surface has a first region configured to contact a side wall of an antihelix. The first region has a protrusion configured to contact an inner side of the antihelix.

### CROSS REFERENCE TO RELATED APPLICATIONS

This Nonprovisional application claims priority under 35 U.S.C. § 119(a) on Patent Application No. 2022-134759 filed in Japan on Aug. 26, 2022, the entire contents of which are hereby incorporated by reference.

### BACKGROUND

### Technical Field

An embodiment of the present disclosure relates to an earphone housing to be worn in the ear for use.

### Background Information

An earphone disclosed in International Publication No. 2021/149425 is a canal type wireless earphone. The earphone has a box-shaped base. The earphone of International Publication No. 2021/149425 is worn such that an inclined portion of the base is hooked on a protruding tip portion of an antihelix.

The earphone of International Publication No. 2021/149425 with a tapered shape does not contact a side wall of an antihelix. Therefore, stability lacks when the earphone of International Publication No. 2021/149425 is worn. The earphone touches an inner side of the antihelix so as to be hooked, at one point of an angle of the taper. Therefore, in wearing the earphone, a user feels uncomfortable because of high pressure on the ear.

### SUMMARY

An embodiment of the present disclosure is directed to provide an earphone housing and an earphone capable of achieving high holding power while reducing pressure on an ear.

An earphone includes an inserter configured to be inserted into an outer ear hole of an ear, a main body configured to be coupled to the inserter, and an earpiece covering the inserter. The main body includes a bottom surface and a side surface that are configured to contact a surface of a cavum concha. The side surface has a first region configured to contact a side wall of an antihelix. The first region has a protrusion configured to contact an inner side of the antihelix.

According to an embodiment of the present disclosure, high holding power is able to be achieved while pressure on an ear is reduced.

### BRIEF DESCRIPTION OF THE DRAWINGS

FIG. 1 is a view showing a state in which an earphone housing is worn in an ear.

FIG. 2 is a perspective view of the earphone housing when the earphone housing is viewed in an arrow Ax1 direction of FIG. 1.

FIG. 3 is a perspective view of the earphone housing as viewed in the arrow Ax1 direction of FIG. 1, and an earpiece is worn in an ear.

FIG. 4 is a side view of the earphone housing viewed from right.

FIG. 5 is a view showing a left ear of a user, that is, a part in contact with the earphone housing when worn.

FIG. 6 is a side view of the earphone housing viewed from left.

FIG. 7 is a back view of the earphone housing viewed from back.

FIG. 8 is a front view of the earphone housing viewed from front.

### DETAILED DESCRIPTION

Hereinafter, an earphone housing 10 according to an embodiment of the present disclosure will be described with reference to the drawings.

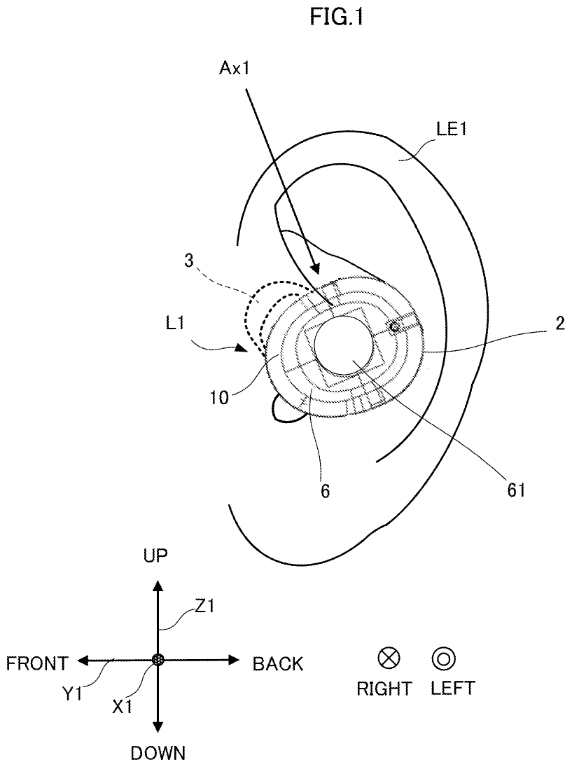

FIG. 1 is a view showing a state in which an earphone housing 10 is worn in an ear.

Hereinafter, in the present embodiment, directions are defined as shown in FIG. 1. Specifically, directions in a state in which a user wears an earphone 1 on the left ear LE1 are defined. The direction in which the earphone housing 10 and the left ear LE1 of the user are aligned is defined as a left-right direction X1. In addition, the direction in which the earphone housing 10 and the left ear LE1 are aligned in this order is defined as a right direction or an insertion direction. Moreover, the vertical direction is defined as an up-down direction Z1. More specifically, the vertical down direction is defined as a down direction, and the vertical up direction is defined as an up direction. In addition, the direction perpendicular to the left-right direction X1 and the up-down direction Z1 is defined as a front-back direction Y1. More specifically, in the front-back direction Y1, the face side is defined as a front direction, and the head side is defined as a back direction.

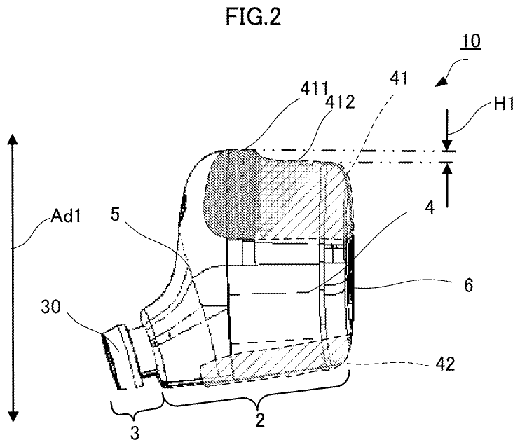

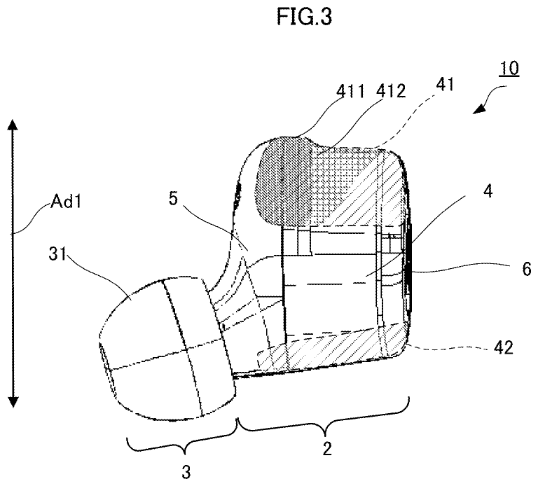

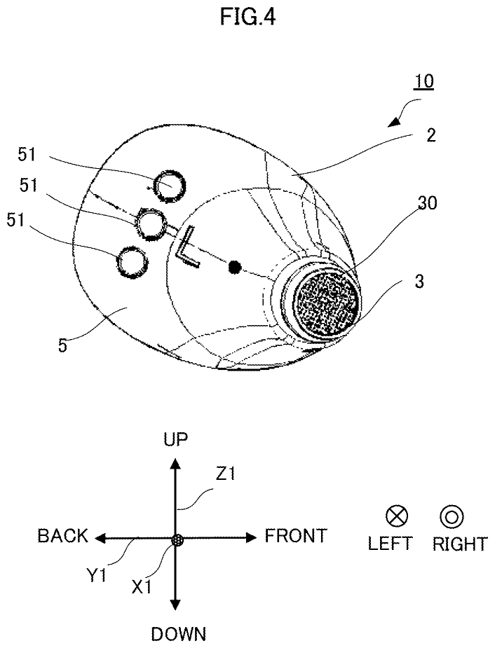

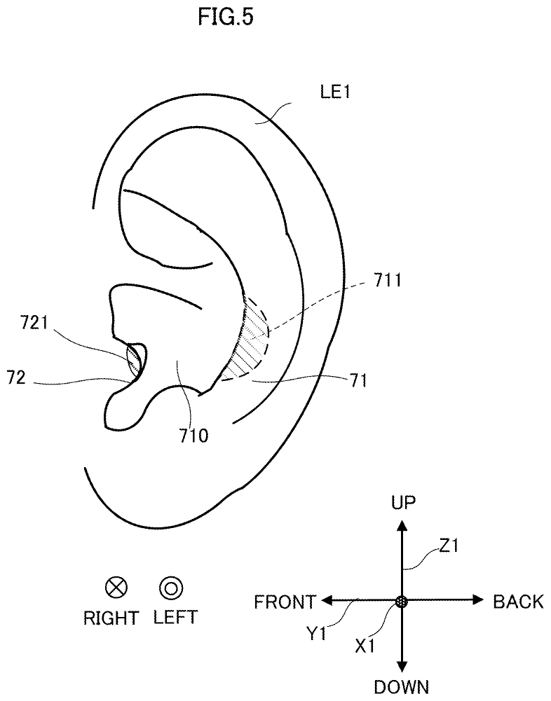

FIG. 2 is a perspective view of the earphone housing 10 when the earphone housing 10 is viewed in an arrow Ax1 direction of FIG. 1. FIG. 3 is a perspective view of the earphone housing 10 with an earpiece 31 as viewed in the arrow Ax1 direction of FIG. 1. FIG. 4 is a side view of the earphone housing 10 viewed from right. FIG. 5 is a view showing the left ear LE1 of the user, that is, a part in contact with the earphone housing 10 when worn. However, the left ear LE1 shown in FIG. 5 is a shape in a state in which the earphone housing 10 is not worn (is not deformed).

It is to be noted that the left-right direction X1, the up-down direction Z1, and the front-back direction Y1 are defined for description. Accordingly, the left-right direction, the up-down direction, and the front-back direction in actual use of the earphone housing 10 do not necessarily have to match the left-right direction X1, the up-down direction Z1, and the front-back direction Y1 in the present embodiment.

The earphone 1 is an audio device that emits sound based on an audio signal. The earphone 1 receives an audio signal from a smartphone, a portable music reproduction apparatus, or an information processing terminal such as a PC, through wireless communication such as Bluetooth (registered trademark). The earphone 1 emits sound based on a received audio signal. It is to be noted that the earphone 1 may be connected to the information processing terminal by wire.

The earphone 1, as shown in FIG. 1, includes two units of a left unit L1 used by being inserted into the left ear LE1 and a right unit R1 (not shown) used by being inserted into a right ear. The user, for example, wears the left unit L1 in the left ear LE1 of the user. In addition, the user, for example, wears the right unit R1 in the right ear of the user. When the user wears the left unit L1, the left unit L1 emits sound to the left ear LE1 of the user. In addition, when the user wears the right unit R1, the right unit R1 emits sound to the right ear (not shown) of the user.

The left unit L1 and the right unit R1 are bilaterally symmetrical. The left unit L1 and the right unit R1 are not in contact with each other (are not connected with a cable or the like, for example). In other words, the earphone 1 is a true wireless earphone including right and left independent units. However, the present disclosure is not limited to a wireless earphone.

In the earphone 1 according to the present embodiment, the left unit L1 and the right unit R1 have the same configuration and function, except for being bilaterally symmetrical. Accordingly, only the left unit L1 will be described, and a description of the right unit R1 will be omitted.

In the following description, the earphone 1 includes an earphone housing 10, and an audio device including an electronic component, for example, that is built in the earphone housing 10. In addition, in the following description, the earphone housing 10 simply indicates only a housing.

The left unit L1 includes an earphone housing 10, a wireless communication device (not shown), a driver unit (not shown), a battery (not shown), a charging terminal, a microphone (not shown), an LED, and a user interface 61. The left unit L1 may include an electronic component other than the wireless communication device, the driver unit, the battery, the charging terminal, the microphone, and the LED. It is to be noted that the wireless communication device, the battery, the charging terminal, the microphone, the LED, and the user interface 61 are not the essential configurations of the left unit L1.

The wireless communication device, for example, receives an audio signal from an information processing terminal (a reproduction apparatus). In addition, the wireless communication device receives a signal according to an operation such as reproduction/stop, a change in sound volume, or the like, from the information processing terminal.

The charging terminal is connected to an external power source, for example, by contacting a terminal on a charging case, in order to charge the battery.

The battery stores electric power supplied from the external power source. The electric power stored in the battery is used to drive the electronic components such as the driver unit, the microphone, and the LED.

The driver unit amplifies an inputted audio signal, converts the signal into an analog signal, and emits sound to the outside.

The microphone collects voice of the user, or external sound for noise cancellation.

The LED, for example, is turned on or off according to ON and OFF of a power source of the earphone 1.

The user interface 61, for example, receives a switching operation of the power source of the earphone 1.

The earphone housing 10, as shown in FIG. 2, includes a main body (a main body portion) 2 and an inserter 3. The main body 2 and the inserter 3 are coupled to each other.

The inserter 3, as shown in FIG. 1, is inserted into the outer ear hole of the left ear LE1. The inserter 3 includes a nozzle 30 (see FIG. 2) and an earpiece 31 (see FIG. 3). The nozzle 30, as shown in FIG. 3, is covered by the earpiece 31. The earpiece 31 may be made of a resin with high flexibility, such as silicone rubber, polyurethane, or epoxy, for example. The earpiece 31 contacts the outer ear hole of the left ear LE1, when the earphone 1 is worn. The earpiece 31 is closely attached to an ear hole, and blocks a sound around the user.

It is to be noted that the earpiece 31 may be integrated with the inserter 3 or may be attachable and detachable. In a case in which the earpiece 31 is attachable and detachable, a plurality of types in different sizes may be prepared. In such a case, the user can select an earpiece of a suitable size according to the size of the ear.

It is to be noted that the earpiece 31 is not an essential configuration in the present disclosure.

The main body 2, as shown in FIG. 2 and FIG. 3, includes a side surface 4 and a bottom surface 5. The bottom surface 5 is coupled to the inserter 3. The main body 2 includes a surface 6 being an outer surface opposite to the bottom surface 5, in the left-right direction X1. The main body 2 is provided in a hollow approximately elliptical cylindrical shape by the side surface 4, the bottom surface 5, and the surface 6. The main body 2 internally stores an electronic component such as a wireless communication device, a driver unit, a battery, a charging terminal, a microphone, an LED, and a user interface 61.

The bottom surface 5, when the earphone 1 is worn, contacts a surface of a cavum concha 710 of the left ear LE1. The bottom surface 5, as shown in FIG. 4, is formed into an ellipse shape, when viewed in the left-right direction X1. More specifically, the bottom surface 5 is formed into a shape that tapers in the front direction, when viewed in the left-right direction X1. The bottom surface 5 follows a shape of an ear (the left ear LE1 in this example). As a result, the earphone housing 10 provides a better fit for the user.

It is to be noted that the bottom surface 5 includes a through hole 51 through which each of a plurality of charging terminals is exposed.

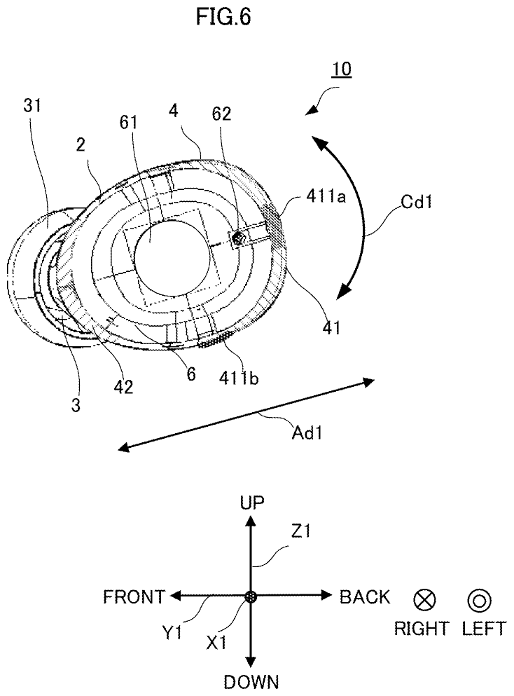

FIG. 6 is a side view of the earphone housing 10 viewed from left. The surface 6 is formed into an ellipse shape, when viewed in the left-right direction X1. More specifically, the surface 6 is formed into an elongated ellipse shape in the front-back direction Y1. The surface 6 is a part on the outside of the ear (the left ear LE1), when the earphone 1 is worn. In the following description, the longitudinal direction of the surface 6 is referred to as a direction Ad1.

The surface 6, as shown in FIG. 6, includes a user interface 61. The user interface 61 may be a power button, for example. The user presses the power button in the insertion direction of the left unit L1. As a result, the user interface 61 receives an on-off operation of the power source. In this manner, the user interface 61 provided on the surface 6 makes it difficult for the left unit L1 to fall from the ear (the left ear LE1) when the user operates the user interface 61.

The side surface 4, as shown in FIG. 2 and FIG. 3, is a surface that couples the bottom surface 5 and the surface 6. The side surface 4 has a first region 41 and a second region 42. The first region 41, as shown in FIG. 6, when viewed in the left-right direction X1, is a region being a backside of the main body 2, when the earphone 1 is worn. The first region 41, as shown in FIG. 5, contacts a side wall of an antihelix 71 of the left ear LE1, when the earphone 1 is inserted. The first region 41, when the earphone 1 is worn, contacts the side wall of the antihelix 71 so as to push toward a backside of the left ear LE1. In addition, the second region 42, when viewed in the left-right direction X1, is a region being a front side of the left ear LE1, when the earphone 1 is worn. The second region 42, when the earphone 1 is worn, contacts a tragus 72 of the left ear LE1.

The first region 41, as shown in FIG. 2 and FIG. 3, includes a protrusion 411. The protrusion 411 protrudes toward the outside of the main body 2 on a side closer to the bottom surface 5 than the surface 6. The protrusion 411, as shown in FIG. 5, contacts a region 711 being an inner side of the antihelix 71 of the left ear LE1, when the earphone 1 is worn.

More specifically, the protrusion 411, as shown in FIG. 6, is provided in a circumferential direction Cd1. The protrusion 411 is provided in about half a length of the side surface 4 in the circumferential direction Cd1.

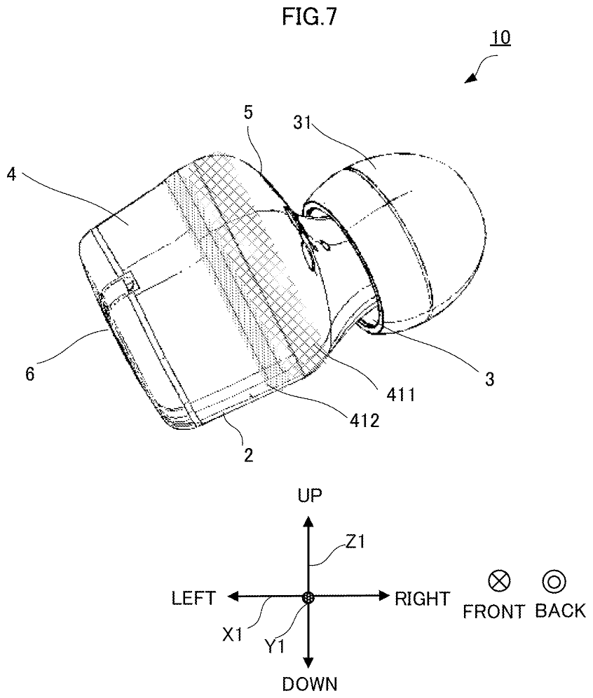

In addition, the first region 41, as shown in FIG. 2 and FIG. 7, has an antihelix contactor 412 on the side of the surface 6 of the protrusion 411. The antihelix contactor 412 contacts the side surface of the antihelix 71, when the earphone 1 is worn.

In this manner, the antihelix contactor 412 contacts the side surface of the antihelix 71, so that the protrusion 411 is stuck in an internal portion (the region 711) of the antihelix 71. As a result, the earphone housing 10 becomes more difficult to fall from the ear (the left ear LE1).

The earphone housing 10 of the present embodiment, when the earphone 1 is worn, by gently pressing the entire side wall of the antihelix 71 by the antihelix contactor 412 in the first region 41, and by further causing the protrusion 411 to be hooked on the inner side of the antihelix 71, is able to achieve high holding power while reducing pressure.

FIG. 7 is a back view of the earphone housing 10 viewed from back. A height H1 of the protrusion 411 shown in FIG. 2 is gradually reduced from the first region 41 toward the second region 42, in the circumferential direction Cd1. In other words, the protrusion 411, in the first region 41, includes a highest part 411a being a top on a backside in the direction Ad1 of the main body 2 (see FIG. 6).

The size and shape of the cavum concha 710 are different depending on the user. In addition, the length between the antihelix 71 and the surface of the cavum concha 710 is different depending on the user. The user, when wearing the earphone 1, first inserts the earphone housing 10 so that a part 411b in which the height H1 of the protrusion 411 is small may touch the inner side of the antihelix 71. Then, the user rotates the earphone housing 10 in the circumferential direction Cd1 so that the height H1 of the protrusion 411 may match the length between the antihelix 71 and the surface of the cavum concha 710 (see FIG. 6). In this manner, in a case in which the user wears the earphone housing 10 in the ear, the height H1 of the protrusion 411 is different in the circumferential direction Cd1, so that the earphone housing 10 is able to achieve both easy wearing and holding capability.

In addition, the second region 42 contacts the tragus 72, when the earphone 1 is worn. More specifically, the second region 42 contacts the tragus 72 so that pressure may be applied to the front side of the ear (the left ear LE1). In this manner, the second region 42 contacts the tragus 72, so that the earphone housing 10 is able to further increase the holding power to the ear (the left ear LE1).

Further, the earphone housing 10 of the present embodiment is able to distribute the pressure applied to the ear (the left ear LE1) since the first region 41 contacts the antihelix 71, and the second region 42 contacts the tragus 72. In other words, the earphone housing 10 of the present embodiment, by distributing the pressure on the tragus 72, the surface of the cavum concha 710, the side surface of the antihelix 71, the internal portion of an antitragus, and the ear hole, is able to achieve high holding power while reducing pressure on each part (the tragus 72, the surface of the cavum concha 710, the side surface of the antihelix 71, the internal portion of the antitragus, and the ear hole) of the ear (the left ear LE1).

It is to be noted that the height H1 of the protrusion 411, in the left-right direction X1, is preferably gradually reduced from the bottom surface 5 toward the surface 6. Specifically, as shown in FIG. 2, the height H1 of the protrusion 411 varies less near the surface 6 and varies more near the bottom surface 5. In other words, the height of the protrusion 411 varies as with an exponential curve of which the inclination is increased from the surface 6 toward the bottom surface 5.

In this manner, the height H1 of the protrusion 411 is gradually reduced from the bottom surface 5 toward the surface 6, so that the earphone housing 10 is held along the shape of the inner side of the antihelix 71. Therefore, the earphone housing 10 is able to increase fit. In other words, the earphone housing 10 is able to block external sound and further provide a sense of immersion to the user.

It is to be noted that the inserter 3, as shown in FIG. 2 and FIG. 4, is preferably coupled to a part other than a center of the bottom surface 5. More specifically, the main body 2 is coupled to the inserter 3 near the second region 42. In this manner, the earphone housing 10, when the main body 2 is coupled to the inserter 3 near the second region 42, is shaped along the shape of the ear (the left ear LE1), and increases fit. In other words, the earphone housing 10 is able to block external sound and further provide a sense of immersion to the user.

It is to be noted that an operation that the user interface 61 receives is not limited to the on-off operation of the power source. For example, the user interface 61 may receive an operation to reproduction or stop reproducing content, or the like.

It is to be noted that the surface 6 preferably includes a through hole 62 that emits light of the LED. The light of the LED is emitted to the outside through the through hole 62. In this manner, the light of the LED is emitted from the surface 6 to the outside, so that the state of the earphone 1 is visibly recognized by people other than the user more easily.

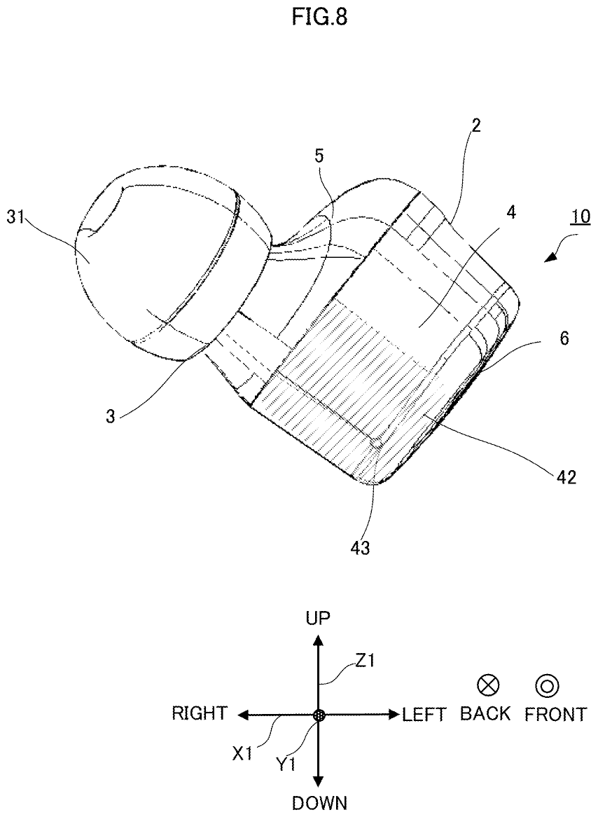

FIG. 8 is a front view of the earphone housing 10 viewed from front. The second region 42 of the side surface 4, as shown in FIG. 8, preferably includes a through hole 43. The microphone collects a sound through the through hole 43. The earphone 1, for example, may be used during a call with another person. The earphone 1 including the microphone enables the user to eliminate the need for a separate microphone, and to talk handsfree to the other person.

It is to be noted that the earphone 1 according to the present embodiment does not have to be right and left independent units. The right and left independent units of the earphone 1 may be connected with a cable.

Finally, the description of the foregoing embodiments is illustrative in all points and should not be construed to limit the present disclosure. The scope of the present disclosure is defined not by the foregoing embodiments but by the following claims. Further, the scope of the present disclosure is intended to include all modifications within the scopes of the claims and within the meanings and scopes of equivalents.

What is claimed is:

1. An earphone housing comprising:
a main body; and
an inserter extending from the main body and configured to be inserted into an outer ear hole of an ear,
wherein the main body includes a bottom surface and a side surface that are configured to contact a surface of a cavum concha of the ear,
wherein the side surface includes a first region configured to contact a side wall of an antihelix of the ear, and
wherein the first region includes a protrusion configured to contact an inner side of the antihelix.

2. The earphone housing according to claim 1, wherein:
the main body includes a second region located opposite to the first region, and
the second region contacts a tragus of the ear.

3. The earphone housing according to claim 1, wherein the bottom surface of the main body is elliptically shaped.

4. The earphone housing according to claim 2, wherein a height of the protrusion gradually reduces from the first region toward the second region.

5. The earphone housing according to claim 1, wherein a height of the protrusion gradually reduces from the bottom surface toward an outer surface opposite to the bottom surface.

6. An earphone comprising:
a main body;
an inserter extending from the main body and configured to be inserted into an outer ear hole of an ear; and
an earpiece covering the inserter,
wherein the main body includes a bottom surface and a side surface that are configured to contact a surface of a cavum concha of the ear,
wherein the side surface includes a first region configured to contact a side wall of an antihelix of the ear, and
wherein the first region includes a protrusion configured to contact an inner side of the antihelix.

7. The earphone according to claim 6, wherein:
the inserter includes a nozzle, and
the earpiece is replaceable and shrouds over the nozzle.

8. The earphone according to claim 7, wherein the nozzle extends outwardly from a side of the bottom surface of the main body.

9. The earphone according to claim 6, further comprising a user interface disposed on an outer side of the main body.
